(19) United States
(12) Patent Application Publication
(10) Pub. No.: US 2012/0302704 A1
(43) Pub. Date: Nov. 29, 2012

(54) COPOLYMER COMPOSED OF A POLYPHENYLENE AND A FLEXIBLE CHAIN COMPONENT

(76) Inventors: Hans-Georg Herz, Marktoberdorf (DE); Maier Gerhard, Muenchen (DE); Philipp Koelle, Stuttgart (DE)

(21) Appl. No.: 13/386,634

(22) PCT Filed: Jul. 23, 2010
(86) PCT No.: PCT/EP2010/060739

§ 371 Date: Jun. 1, 2012

(30) Foreign Application Priority Data
Jul. 24, 2009 (DE) 102009027983.0

(51) Int. Cl. C08G 61/10

(52) U.S. Cl. 525/418

(57) ABSTRACT

A copolymer is described which is prepared by reacting a polyphenylene having two terminal coupling groups X₁ and X₂ with a flexible chain component which has a flexible chain having two terminal coupling groups Y₁ and Y₂. A high modulus of elasticity, high media resistance, and cost-effective, large-scale production may be achieved in that the flexible chain has a chain length of less than or equal to 95 chain atoms, and each of coupling groups X₁ and X₂ reacts with one of coupling groups Y₁ and Y₂, forming a bond selected from the group composed of carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bonds.

### FIELD OF THE INVENTION

The present invention relates to a copolymer, a polymer mixture including such a copolymer, a method for preparing such a copolymer, and the use of such a copolymer.

### BACKGROUND INFORMATION

Thermoplastic polymers available heretofore usually have inadequate mechanical properties for certain applications, in particular at elevated temperatures and under the influence of media such as fuel, motor oil, and brake fluid. In particular, the rigidity in combination with a high tensile strength and vibration resistance is frequently inadequate.

Certain glass fiber-reinforced polyamides may have a high tensile strength in the processing direction (flow direction); however, materials of this type are often anisotropic, and do not have sufficient strength transverse to the processing direction (flow direction).

Polyphenylenes may have high mechanical strengths and rigidities. Several polyphenylenes are discussed in U.S. Pat. No. 5,654,392 and U.S. Pat. No. 5,670,564, for example.

However, polyphenylenes may be soluble in a number of solvents, which may result in limited media resistance against fuel, motor oil, and similar media.

### SUMMARY OF THE INVENTION

The subject matter of the present invention is a copolymer, in particular a block copolymer, which is prepared by reacting a polyphenylene having two terminal coupling groups X₁ and X₂ with a flexible chain component which has a flexible chain having two terminal coupling groups Y₁ and Y₂; according to the present invention, each of coupling groups X₁ and X₂ reacts with one of coupling groups Y₁ and Y₂, forming a bond selected from the group composed of a carboxylic acid amide bond (also referred to as an amide bond), a carboxylic acid ester bond (also referred to as an ester bond), a carboxylic acid imide bond (also referred to as an imide bond), a urethane bond, a carbonate bond, a urea bond, a thiourea bond, a sulfonic acid amide bond (also referred to as a sulfonamide bond), a sulfonic acid ester bond (also referred to as a sulfonic ester bond), an imidazole bond, an oxazole bond, a thiazole bond, an oxazoline bond, an imidazoline bond, an amine bond, an ether bond, and a thioether bond, in particular a carboxylic acid amide bond, and the flexible chain has a chain length of less than or equal to 95 chain atoms.

In particular, the carboxylic acid imide bond may be a phthalimide bond, and/or the imidazole bond may be a benzimidazole bond, and/or the oxazole bond may be a benzoxazole bond, and/or the thiazole bond may be a benzothiazole bond.

The above-mentioned bonds are understood to mean in particular bonds according to the following structural formulas, where R′, R′a, R′b, R′c and R′d on the one hand stand for the polyphenylene, and R″ on the other hand stands for the flexible chain, where R″′ and R″″ stand for hydrogen or some other substituent, or for another area of the polyphenylene or the flexible chain.

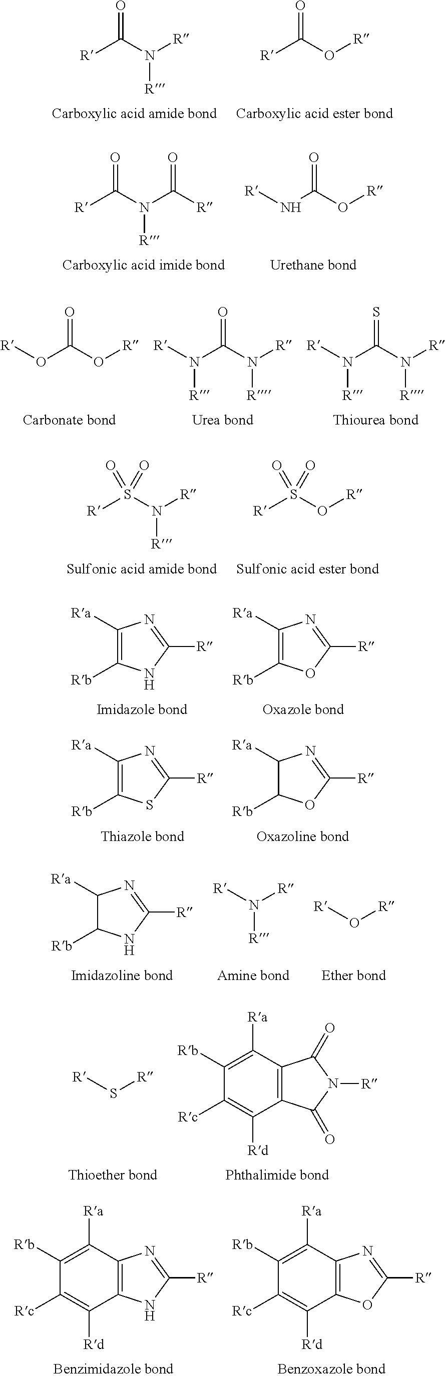

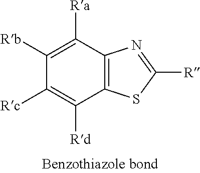

Copolymers of this type may advantageously have improved media resistance against fuel, motor oil, and similar media. In addition, copolymers of this type may advantageously have high intrinsic rigidity. This has the advantage that the copolymers according to the present invention may also be used for components in contact with media in the automotive sector. Furthermore, copolymers of this type may advantageously be processed thermoplastically. A high rigidity may advantageously be ensured as a result of the polyphenylene. As a result of the flexible chain component, the processing temperature may advantageously be reduced and a greater distance to the decomposition temperature may be established.

The fact that coupling groups X₁, X₂ each react with one of coupling groups Y₁, Y₂, forming a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, or thioether bond, in particular a carboxylic acid amide bond, may be advantageous since many of the corresponding starting compounds are easily and/or inexpensively obtainable. In addition, the reaction may thus take place on the commercial scale in the melt, in particular in an extruder or kneader. This may in turn be advantageous, since starting compounds may also be used which are poorly soluble in solvents.

The use of a flexible chain component whose flexible chain has a chain length of less than or equal to 95 chain atoms has proven to be advantageous within the scope of the present invention, since copolymers having improved modulus of elasticity may be prepared using chain components of this type (see examples).

Within the meaning of the present invention, a “flexible chain” is understood to mean in particular a chain including carbon atoms and optionally heteroatoms, and including at least one at least partially rotatable single bond. The flexible chain may, for example, include at least one sp³-hybridized carbon atom and/or at least one oxygen atom and/or at least one sulfur atom which form(s) at least one at least partially rotatable single bond with a further chain atom. In addition, the flexible chain may include nonrotatable bonds (double bonds and/or triple bonds, in particular conjugated and/or aromatic bonds), i.e., sp-hybridized and/or sp²-hybridized carbon atoms. For example, in addition to rotatable bonds, i.e., sp³-hybridized carbon atoms, oxygen atoms and/or sulfur atoms, the flexible chain may also include nonrotatable bonds (double bonds and/or triple bonds, in particular conjugated and/or aromatic bonds), i.e., sp-hybridized and/or sp²-hybridized carbon chain atoms, which are part of a unit, for example a substituted or unsubstituted arylene unit, in particular a phenylene unit, and/or a carboxylic acid amide group. One example of a flexible chain component whose flexible chain includes rotatable single bonds as well as nonrotatable bonds (emphasized by thicker lines) is the following:

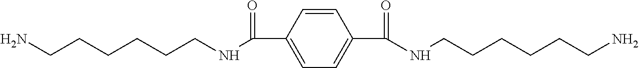

Preferably at least 5%, for example at least 15% or at least 45% or at least 50% or at least 60%, in particular at least 80% or at least 90%, of the chain atoms of the flexible chain are sp³-hybridized carbon atoms. Preferably 95% maximum, for example 85% maximum or 55% maximum or 50% maximum or 40% maximum, in particular 20% maximum or 10% maximum, of the chain atoms of the flexible chain are sp-hybridized, sp²-hybridized, and/or aromatic carbon atoms.

The flexible chain may in particular have a chain length of less than or equal to 90 chain atoms, for example less than or equal to 80 chain atoms or less than or equal to 70 chain atoms. Furthermore, the flexible chain may have a chain length of greater than or equal to 6 chain atoms, for example greater than or equal to 7, 8, 9, 10, 11, or 12 chain atoms, in particular greater than 12 chain atoms. For example, the flexible chain may have a chain length of ≧6, ≧7, ≧8, ≧9, ≧10, ≧11, or ≧12 chain atoms, and ≦95, ≦90, ≦80, or ≦70 chain atoms. A flexible chain component whose flexible chain has a chain length of greater than 12 chain atoms has proven to be advantageous, since copolymers having improved modulus of elasticity may be prepared using chain components of this type.

In principle, the flexible chain may be formed from multiple structurally different units or atoms, or also from up to ten structurally identical units or from more than ten structurally identical units. A chain formed from up to ten structurally identical units is understood to mean an oligomer, and a chain formed from more than ten structurally identical units is understood to mean a polymer.

For example, the flexible chain may be:
an alkane, in particular including 6 to 30 carbon atoms, for example ethane, propane, butane, pentane, hexane, octane, decane, or dodecane, for example hexane, octane, decane, or dodecane, or
an alkene, in particular including 6 to 30 carbon atoms, or
an alkyne, in particular including 6 to 30 carbon atoms, or
a chain including aromatic chain atoms, for example 2, 2′-bis-[4-phenoxyphenyl]propane, 1,2-phenylene, 1,3-phenylene, 1,4-phenylene, diphenyl ether, a dialkylterephthalamide, a dialkylisophthalamide, or a dialkylphthalamide, for example dihexylterephthalamide, dihexylisophthalamide, dihexylphthalamide, or
a chain including cycloaliphatic chain atoms, for example methyl-bis-cyclohexyl, 1,3-bis-(methyl)cyclohexane, or trans-1,4-cyclohexane,
a polymer, for example a polyamide, polycarbonate, polyester, polyesteramide, polyester carbonate, polyesterimide, polythioester, polyether, polythioether, polyimide, polyamide-imide, polybenzimidazole, polybenzoxazole, polybenzothiazole, polyurethane, polyurea, polyoxazoline, poly(meth)acrylate, polysulfone, polyether ketone, polyether imide, polyether sulfone, or polyimide sulfone, or
an oligomer, for example a dialkyl(oligoterephthalalkylamide), a dialkyl(oligoisophthalalkylamide), a dialkyl(oligophthalalkylamide), an oligoamide, oligocarbonate, oligoester, oligoester amide, oligoester carbonate, oligoester imide, oligothioester, oligoether, oligothioether, oligoimide, oligoamide-imide, oligobenzimidazole, oligobenzoxazole, oligobenzothiazole, oligourethane, oligourea, oligooxazoline, oligo(meth)acrylate, oligosulfone, oligoether ketone, oligoether imide, oligoether sulfone, or oligoimide sulfone.

The polyphenylene may have, for example, an average number of phenylene units greater than or equal to 10 and/or less than or equal to 100, in particular greater than or equal to 30 and/or less than or equal to 70.

Within the scope of one specific embodiment of the present invention, the polyphenylene has an average number of phenylene units greater than or equal to 40 and/or less than or equal to 60. The use of polyphenylenes of this type has proven to be particularly advantageous within the scope of the present invention, since polyphenylenes having an average number of phenylene units greater than or equal to 40 have relatively high rigidity, and polyphenylenes having an average number of phenylene units less than or equal to 60 may still be satisfactorily processed.

Coupling groups X₁ and X₂ and/or Y₁ and Y₂ may each independently stand for a carboxylic acid ester group, a carboxylic acid anhydride group, a carboxylic acid halide group, in particular a carboxylic acid chloride group, a carboxylic acid group, a nitrile group, an oxazoline group, an isocyanate group, a thioisocyanate group, a sulfonic acid group, a sulfonic acid halide group, in particular a sulfonic acid chloride group, a sulfonic acid ester group, an aromatic diamino group, in particular an ortho-diamino group, a halogen group, for example fluorine, chlorine, or bromine, in particular an aromatic halogen group, a nitro group, in particular an aromatic nitro group, an acetylene group, an epoxy group, an amine group, a thiol group, or an alcohol group. Coupling groups X₁, X₂, Y₁, and Y₂ are preferably selected in such a way that each of coupling groups X₁ and X₂ is able to react with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, in particular a carboxylic acid amide bond.

For example, a carboxylic acid amide bond may be obtained by reacting a carboxylic acid or a carboxylic acid halide, in particular a carboxylic acid chloride, or a carboxylic acid ester or a nitrile (CN) or an oxazoline with an amine, or reacting an oxazoline with an alcohol or a carboxylic acid or a carboxylic acid halide, in particular a carboxylic acid chloride, a carboxylic acid ester, or a nitrile, in particular reacting an oxazoline with an alcohol or a carboxylic acid. For example, for this purpose coupling groups X₁ and X₂ may each independently stand for a carboxylic acid group, a carboxylic acid halide group, in particular a carboxylic acid chloride group, a carboxylic acid ester group, a nitrile group, or an oxazoline group, and coupling groups Y₁ and Y₂ may stand for an amine group, or coupling groups Y₁ and Y₂ may each independently stand for a carboxylic acid group, a carboxylic acid halide group, in particular a carboxylic acid chloride group, a carboxylic acid ester group, a nitrile group, or an oxazoline group, and coupling groups X₁ and X₂ may stand for an amine group. Likewise, one of coupling groups X₁ and X₂ or Y₁ and Y₂ may stand for a carboxylic acid group, a carboxylic acid halide group, in particular a carboxylic acid chloride group, a carboxylic acid ester group, a nitrile group, or an oxazoline group, and the other coupling group X₁ or X₂, or Y₁ or Y₂, may stand for an amine group. For the case that one of coupling groups X₁ and X₂ or Y₁ and Y₂ stands for an oxazoline group, the other coupling group X₁ or X₂, or Y₁ or Y₂, may, for example, stand for an amine group, an alcohol group, a carboxylic acid group, a carboxylic acid halide group, in particular a carboxylic acid chloride group, a carboxylic acid ester group, or a nitrile group, in particular an amine group, an alcohol group, or a carboxylic acid group.

In addition, for example, a carboxylic acid ester bond may be obtained by reacting a carboxylic acid or a carboxylic acid halide, in particular a carboxylic acid chloride, or a carboxylic acid ester or a nitrile with an alcohol, for example a phenol. For example, for this purpose coupling groups X₁ and X₂ may each independently stand for a carboxylic acid group, a carboxylic acid halide group, in particular a carboxylic acid chloride group, a carboxylic acid ester group, or a nitrile group, and coupling groups Y₁ and Y₂ may stand for an alcohol group, or coupling groups Y₁ and Y₂ may each independently stand for a carboxylic acid group, a carboxylic acid halide group, in particular a carboxylic acid chloride group, a carboxylic acid ester group, or a nitrile group, and coupling groups X₁ and X₂ may stand for an alcohol group. Likewise, one of coupling groups X₁ and X₂ or Y₁ and Y₂ may stand for a carboxylic acid group, a carboxylic acid halide group, in particular a carboxylic acid chloride group, a carboxylic acid ester group, or a nitrile group, and the other coupling group X₁ or X₂, or Y₁ or Y₂, may stand for an alcohol group.

A carboxylic acid imide bond may be obtained, for example, by reacting a carboxylic acid anhydride with an amine. For example, for this purpose coupling groups X₁ and X₂ may stand for a carboxylic acid anhydride group, and coupling groups Y₁ and Y₂ may stand for an amine group, or coupling groups Y₁ and Y₂ may stand for a carboxylic acid anhydride group, and coupling groups X₁ and X₂ may stand for an amine group.

Likewise, one of coupling groups X₁ and X₂ or Y₁ and Y₂ may stand for a carboxylic acid anhydride group, and the other coupling group X₁ or X₂, or Y₁ or Y₂, may stand for an amine group.

A urethane bond may be obtained, for example, by reacting an isocyanate with an alcohol. For example, for this purpose coupling groups X₁ and X₂ may stand for an isocyanate group, and coupling groups Y₁ and Y₂ may stand for an alcohol group, or coupling groups Y₁ and Y₂ may stand for an isocyanate group, and coupling groups X₁ and X₂ may stand for an alcohol group. Likewise, one of coupling groups X₁ and X₂ or Y₁ and Y₂ may stand for an isocyanate group, and the other coupling group X₁ or X₂, or Y₁ or Y₂, may stand for an alcohol group.

A carbonate bond may be obtained, for example, by reacting phosgene with an alcohol, for example phenol. For example, for this purpose coupling groups X₁ and X₂ and/or Y₁ and Y₂ may stand for an alcohol group, for example an aromatic alcohol group.

A urea bond may be obtained, for example, by reacting an isocyanate with an amine. For example, for this purpose coupling groups X₁ and X₂ may stand for an isocyanate group, and coupling groups Y₁ and Y₂ may stand for an amine group, or coupling groups Y₁ and Y₂ may stand for an isocyanate group, and coupling groups X₁ and X₂ may stand for an amine group. Likewise, one of coupling groups X₁ and X₂ or Y₁ and Y₂ may stand for an isocyanate group, and the other coupling group X₁ or X₂, or Y₁ or Y₂, may stand for an amine group.

A thiourea bond may be obtained, for example, by reacting a thioisocyanate with an amine. For example, for this purpose coupling groups X₁ and X₂ may stand for a thioisocyanate group, and coupling groups Y₁ and Y₂ may stand for an amine group, or coupling groups Y₁ and Y₂ may stand for a thioisocyanate group, and coupling groups X₁ and X₂ may stand for an amine group. Likewise, one of coupling groups X₁ and X₂ or Y₁ and Y₂ may stand for a thioisocyanate group, and the other coupling group X₁ or X₂, or Y₁ or Y₂, may stand for an amine group.

For example, a sulfonic acid amide bond may be obtained by reacting a sulfonic acid (—SO₃H) or a sulfonic acid halide, in particular a sulfonic acid chloride (—SO₂Cl), or a sulfonic acid ester (—SO₃R), with an amine. For example, for this purpose coupling groups X₁ and X₂ may each independently stand for a sulfonic acid group, a sulfonic acid halide group, in particular a sulfonic acid chloride group, or a sulfonic acid ester group, and coupling groups Y₁ and Y₂ may stand for an amine group, or coupling groups Y₁ and Y₂ may each independently stand for a sulfonic acid group, a sulfonic acid halide group, in particular a sulfonic acid chloride group, or a sulfonic acid ester group, and coupling groups X₁ and X₂ may stand for an amine group. Likewise, one of coupling groups X₁ and X₂ or Y₁ and Y₂ may stand for a sulfonic acid group, a sulfonic acid halide group, in particular a sulfonic acid chloride group, or a sulfonic acid ester group, and the other coupling group X₁ or X₂, or Y₁ or Y₂, may stand for an amine group.

Furthermore, for example, a sulfonic acid ester bond may be obtained by reacting a sulfonic acid or a sulfonic acid halide, in particular a sulfonic acid chloride, or a sulfonic acid ester, with an amine. For example, for this purpose coupling groups X₁ and X₂ may each independently stand for a sulfonic acid group, a sulfonic acid halide group, in particular a sulfonic acid chloride group, or a sulfonic acid ester group, and coupling groups Y₁ and Y₂ may stand for an alcohol group, or coupling groups Y₁ and Y₂ may each independently stand for a sulfonic acid group, a sulfonic acid halide group, in particular a sulfonic acid chloride group, or a sulfonic acid ester group, and coupling groups X₁ and X₂ may stand for an alcohol group. Likewise, one of coupling groups X₁ and X₂ or Y₁ and Y₂ may stand for a sulfonic acid group, a sulfonic acid halide group, in particular a sulfonic acid chloride group, or a sulfonic acid ester group, and the other coupling group X₁ or X₂, or Y₁ or Y₂, may stand for an alcohol group.

An imidazole bond may be obtained, for example, by reacting a diamine, in particular an aromatic diamine, for example an aromatic ortho-diamine, for example 1,2-diaminobenzene, with a carboxylic acid. For example, for this purpose coupling groups X₁ and X₂ may stand for a diamino group, in particular an aromatic diamino group, for example an aromatic ortho-diamino group, and coupling groups Y₁ and Y₂ may stand for a carboxylic acid group, a carboxylic acid amide group, a carboxylic acid ester, or a carboxylic acid halide, in particular a carboxylic acid chloride group, or coupling groups Y₁ and Y₂ may stand for a diamino group, in particular an aromatic diamino group, for example an aromatic ortho-diamino group, and coupling groups X₁ and X₂ may stand for a carboxylic acid group, a carboxylic acid amide group, a carboxylic acid ester, or a carboxylic acid halide, in particular a carboxylic acid chloride group. Likewise, one of coupling groups X₁ and X₂ or Y₁ and Y₂ may stand for a diamino group, in particular an aromatic diamino group, for example an aromatic ortho-diamino group, and the other coupling group X₁ or X₂, or Y₁ or Y₂, may stand for a carboxylic acid group, a carboxylic acid amide group, a carboxylic acid ester, or a carboxylic acid halide, in particular a carboxylic acid chloride group.

An amine bond may be obtained, for example, by reacting an epoxy with an amine. For example, for this purpose coupling groups X₁ and X₂ may stand for an epoxy group, and coupling groups Y₁ and Y₂ may stand for an amine group, or coupling groups Y₁ and Y₂ may stand for an epoxy group, and coupling groups X₁ and X₂ may stand for an amine group. Likewise, one of coupling groups X₁ and X₂ or Y₁ and Y₂ may stand for an epoxy group, and the other coupling group X₁ or X₂, or Y₁ or Y₂, may stand for an amine group.

An ether bond may be obtained, for example, by reacting an epoxy or an aromatic halogen with an alcohol, for example an aromatic alcohol. For example, for this purpose coupling groups X₁ and X₂ may stand for an epoxy group, an aromatic halogen, or an aromatic nitro group, and coupling groups Y₁ and Y₂ may stand for an alcohol group, for example an aromatic alcohol group, or coupling groups Y₁ and Y₂ may stand for an epoxy group or an aromatic halogen, and coupling groups X₁ and X₂ may stand for an alcohol group, for example an aromatic alcohol group. Likewise, one of coupling groups X₁ and X₂ or Y₁ and Y₂ may stand for an epoxy group or an aromatic halogen, and the other coupling group X₁ or X₂, or Y₁ or Y₂, may stand for an alcohol group, for example an aromatic alcohol group.

A thioether bond may be obtained, for example, by reacting an aromatic halogen with a thiol, for example an aromatic thiol. For example, for this purpose coupling groups X₁ and X₂ may stand for an aromatic halogen or an aromatic nitro group, and coupling groups Y₁ and Y₂ may stand for a thiol group, for example an aromatic thiol group, or coupling groups Y₁ and Y₂ may stand for an aromatic halogen, and coupling groups X₁ and X₂ may stand for a thiol group, for example an aromatic thiol group. Likewise, one of coupling groups X₁ and X₂ or Y₁ and Y₂ may stand for an aromatic halogen, and the other coupling group X₁ or X₂, or Y₁ or Y₂, may stand for a thiol group, for example an aromatic thiol group.

Within the scope of another specific embodiment of the present invention, coupling groups X₁ and X₂ each independently stand for a carboxylic acid ester group, a carboxylic acid halide group, in particular a carboxylic acid chloride group, or a carboxylic acid group, and coupling groups Y₁ and Y₂ stand for an amine group. This has the advantage that a plurality of compounds which are easily or inexpensively producible and/or commercially available may be used as the flexible chain component, the preparation of the corresponding polyphenylene optionally also being easier or less expensive than for a reverse selection of the coupling groups.

Within the scope of another specific embodiment of the present invention, the polyphenylene and the flexible chain component are used in a ratio of 1:10 to 10:1, for example 1:2 to 2:1, in particular 1:1.5 to 1.5:1. In particular, the polyphenylene and the flexible chain component may be used essentially in a 1:1 ratio. In this regard, “essentially” means in particular that deviations by ±5 mole percent from the ideal 1:1 ratio are included. As the result of the polyphenylene and the flexible chain component being used in a ratio of 1:10 to 10:1 up to essentially a 1:1 ratio, on the one hand the desired chain length of the flexible chain may be set. On the other hand, a fairly large excess and the associated costs may thus be avoided.

Within the scope of another specific embodiment of the present invention, the reaction mixture includes ≧80% by weight to ≧99% by weight polyphenylene and ≧1% by weight to ≦20% by weight flexible chain component. In particular, the reaction mixture may include ≧85% by weight to ≦97% by weight polyphenylene and ≧3% by weight to ≦15% by weight flexible chain component. In this way a copolymer may be prepared which includes essentially ≧80% by weight to ≦99% by weight polyphenylene and ≧1% by weight to ≦20% by weight flexible chain component, in particular ≧85% by weight to ≦97% by weight polyphenylene and ≧3% by weight to ≦15% by weight flexible chain component, which has proven to be advantageous for the modulus of elasticity of the copolymer.

The polyphenylene may have an average molecular weight of ≧40,000 g/mol to ≦2000 g/mol, for example ≧20,000 g/mol to ≦4000 g/mol, in particular ≧12,000 g/mol to ≦6000 g/mol. The flexible chain component may have an average molecular weight of ≧3000 g/mol to ≦60 g/mol, for example ≧1500 g/mol to ≦80 g/mol, in particular ≧400 g/mol to ≦100 g/mol. The use of these types of polyphenylenes or flexible chain components may be advantageous for preparing copolymers having a suitable modulus of elasticity.

Within the scope of another specific embodiment of the present invention, the reaction takes place in the melt, in particular in an extruder or kneader. Starting compounds may thus also be used which are poorly soluble in solvents. In addition, the reaction may take place in an extruder or kneader, optionally under milder conditions than in a simple melt.

In principle, the polyphenylene may be a completely para-linked polyphenylene, a completely ortho-linked polyphenylene, or a completely meta-linked polyphenylene, as well as a mixed para-, ortho-, and/or meta-linked polyphenylene. In particular, the polyphenylene may be a para-polyphenylene.

Within the scope of another specific embodiment of the present invention, the polyphenylene is a polyphenylene of general formula (I):

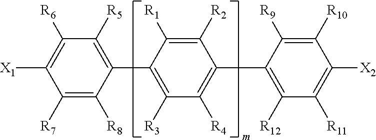

or of general formula (II):

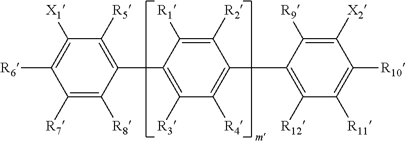

or of general formula (III):

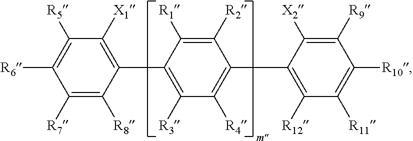

where
R₁ through R₁₂, R₁′ through R₁₂′, R₁″ through R₁₂″ each independently stand for hydrogen, an alkyl group, a heteroalkyl group, an alkyl ketone group, a heteroalkyl ketone group, an alkenyl group, an alkynyl group, an aryl group, a heteroaryl group, an alkoxy group, an aryloxy group, a heteroaryloxy group, an aralkyl group, a heteroaralkyl group, an alkaryl group, a heteroalkaryl group, an acyl group, a carboxylic acid group, a carboxylic acid ester group, a carboxylic acid alkyl ester group, a carboxylic acid aryl ester group, a carboxylic acid amide group, an alkylamide group, a dialkylamide group, an arylamide group, a diarylamide group, an alkylarylamide group, an alkyl ether group, an aryl ether group, an alkyl sulfide group, an aryl sulfide group, a sulfonyl group, an alkylsulfonyl group, an arylsulfonyl group, a thioether group, a halogen group, a haloalkyl group, a haloaryl group, a hydroxy group, or a silyl group, for example for hydrogen, a phenyl group, a biphenyl group, a naphthyl group, a phenanthryl group, an anthracenyl group, a benzyl group, a benzoyl group, a naphthoyl group, a phenoxy group, a phenoxyphenyl group, a phenoxybenzoyl group, or a pyridyl group,
m, m′, m″ stand for the average number of repeating units, and
X₁ and X₂, X₁′ and X₂′, X₂″ and X₂″ stand for coupling groups.

As explained above, m, m′, m″ may be greater than or equal to 10 and/or less than or equal to 100 (10≦m≦100), in particular greater than or equal to 30 and/or less than or equal to 70 (30≦m≦70), preferably greater than or equal to 40 and/or less than or equal to 60 (40≦m≦60), or coupling groups X₁ and X₂, X₁′ and X₂′, X₂″ and X₂″ may each independently stand for a carboxylic acid ester group, a carboxylic acid anhydride group, a carboxylic acid halide group, in particular a carboxylic acid chloride group, a carboxylic acid group, a nitrile group, an oxazoline group, an isocyanate group, a thioisocyanate group, a sulfonic acid group, a sulfonic acid halide group, in particular a sulfonic acid chloride group, a sulfonic acid ester group, an aromatic diamino group, in particular an ortho-diamino group, a halogen group, for example fluorine, chlorine, or bromine, in particular an aromatic halogen group, a nitro group, in particular an aromatic nitro group, an acetylene group, an epoxy group, an amine group, a thiol group, or an alcohol group, for example for a carboxylic acid ester group, a carboxylic acid anhydride group, a carboxylic acid halide group, for example a carboxylic acid chloride group, a carboxylic acid group, an isocyanate group, an oxazoline group, a halogen group, for example fluorine, chlorine, or bromine, an acetylene group, an epoxy group, an amine group, or an alcohol group, in particular for a carboxylic acid ester group, a carboxylic acid halide group, for example a carboxylic acid chloride group, or a carboxylic acid group.

Within the scope of another specific embodiment of the present invention, R₄ stands for a benzoyl group, and R₁, R₂, R₃, and R₅ through R₁₂ stand for hydrogen.

Within the scope of another specific embodiment of the present invention, the flexible chain component is
a diaminoalkane, in particular having terminal amine groups in each case, further including in particular 6 to 30 carbon atoms, for example 1,2-diaminoethane, 1,3-diaminopropane, 1,4-diaminobutane, 1,5-diaminopentane, 1,6-diaminohexane, 1,8-diaminooctane, 1,10-diaminodecane, or 1,12-diaminododecane, for example 1,6-diaminohexane, 1,8-diaminooctane, 1,10-diaminodecane, or 1,12-diaminododecane, or
a diaminoalkene, in particular having terminal amine groups in each case, further including in particular 6 to 30 carbon atoms, or
a diaminoalkyne, in particular having terminal amine groups in each case, further including in particular 6 to 30 carbon atoms, or
a diaminoalkylterephthalamide, a diaminoalkylisophthalamide, or a diaminoalkylphthalamide, in particular having terminal amine groups in each case, or
an aromatic diamine, in particular having terminal amine groups in each case, for example 2, 2′-bis-[4-(4-aminophenoxy)phenyl]propane, 1,2-phenylenediamine, 1,3-phenylenediamine, 1,4-phenylenediamine, or 4,4′-oxydianiline, or
a cycloaliphatic diamine, in particular having terminal amine groups in each case, for example 4, 4′-methyl-bis-cyclohexylamine, 1,3-bis-(aminomethyl)cyclohexane, or trans-1,4-diaminocyclohexane, or
a diamino polymer, in particular having terminal amine groups in each case, for example a diaminopolyamide, a diaminopolycarbonate, a diaminopolyester, a diaminopolyesteramide, a diaminopolyester carbonate, a diaminopolyesterimide, a diaminopolythioester, a diaminopolyether, a diaminopolythioether, a diaminopolyimide, a diaminopolyamide-imide, a diaminopolybenzimidazole, a diaminopolybenzoxazole, a diaminopolybenzothiazole, a diaminopolyurethane, a diaminopolyurea, a diaminopolyoxazoline, a diaminopoly(meth)acrylate, a diaminopolysulfone, a diaminopolyether ketone, a diaminopolyether imide, a diaminopolyether sulfone, or a diaminopolyimide sulfone, or
a diamino oligomer, in particular having terminal amine groups in each case, for example a diaminoalkyl(oligoterephthalalkylamide), a diaminoalkyl(oligoisophthalalkylamide), a diaminoalkyl(oligophthalalkylamide), a diamino-oligoamide, a diamino-oligocarbonate, a diamino-oligoester, a diamino-oligoester amide, a diamino-oligoester carbonate, a diamino-oligoester imide, a diamino-oligothioester, a diamino-oligoether, a diamino-oligothioether, a diamino-oligoimide, a diamino-oligoamidoimide, a diamino-oligobenzimidazole, a diamino-oligobenzoxazole, a diamino-oligobenzothiazole, a diamino-oligourethane, a diamino-oligourea, a diamino-oligooxazoline, a diamino-oligo(meth)acrylate, a diamino-oligosulfone, a diamino-oligoether ketone, a diamino-oligoether imide, a diamino-oligoether sulfone, or a diamino-oligoimide sulfone, for example a diaminoalkyl(oligoterephthalalkylamide) of general formula (III):

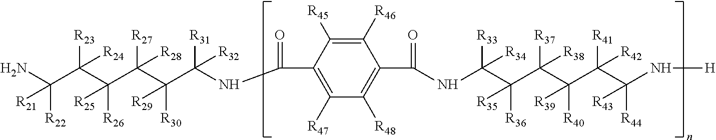

where
R₂₃ through R₄₄ each independently stand for hydrogen or an alkyl group, for example a methyl group or ethyl group, n stands for the average number of repeating units, and is greater than or equal to 1 and less than or equal to 7, for example di-(6-aminohexyl)terephthalamide, or a diaminoalkyl(oligoisophthalalkylamide) of general formula (IV):

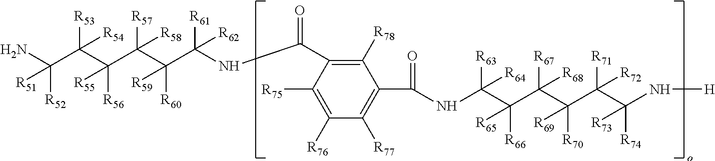

where
R₅₁ through R₇₈ each independently stand for hydrogen or an alkyl group, for example a methyl group or ethyl group,
o stands for the average number of repeating units, and is greater than or equal to 1 and less than or equal to 7, or di-(6-aminohexyl)isophthalamide, for example, or
a diaminoalkyl(oligophthalalkylamide) of general formula (V):

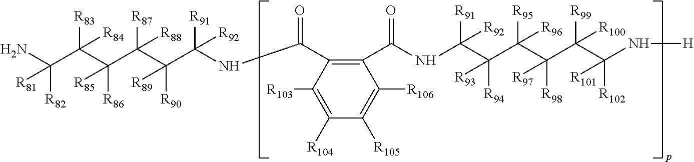

where
R₈₁ through R₁₀₆ each independently stand for hydrogen or an alkyl group, for example a methyl group or ethyl group,
p stands for the average number of repeating units, and is greater than or equal to 1 and less than or equal to 7, or di-(6-aminohexyl)phthalamide, for example.

As a function of the particular synthesis path, the polyphenylene and/or the flexible chain component may optionally be prepared in situ. In particular, the flexible chain component, as a function of the particular synthesis path, may be prepared in the presence of the (completed) polyphenylene. However, it is equally possible to prepare the polyphenylene and the flexible chain component separately from one another. In this regard, the polyphenylene and/or the flexible chain component may be purified with regard to the average number of repeating units, for example. In this way, specialized copolymers for various fields of application may be prepared in an extruder, in particular without the use of solvents and the associated costs.

Another subject matter is a polymer mixture including a copolymer according to the present invention.

With regard to further technical features of the polymer mixture according to the present invention, explicit reference is hereby made to the technical features explained in conjunction with the copolymer according to the present invention.

Another subject matter is a method for preparing a copolymer in which a polyphenylene having two terminal coupling groups X₁ and X₂ is reacted with a flexible chain component which has a flexible chain having two terminal coupling groups Y₁ and Y₂, each of coupling groups X₁ and X₂ reacting with one of coupling groups Y₁ and Y₂, forming a bond selected from the group composed of carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bonds, in particular a carboxylic acid amide bond, and the flexible chain having a chain length of less than or equal to 95 chain atoms.

With regard to further technical features of the method according to the present invention, explicit reference is hereby made to the technical features explained in conjunction with the copolymer according to the present invention and the polymer mixture according to the present invention.

Another subject matter is the use of a copolymer according to the present invention, a polymer mixture according to the present invention, or a copolymer prepared using the method according to the present invention in a component, in particular of a vehicle, for example in a component which is in contact with a solvent (fuel, motor oil, brake fluid) for the engine compartment and/or chassis area of a motor vehicle, for example.

With regard to further technical features of the use according to the present invention, explicit reference is hereby made to the technical features explained in conjunction with the copolymer according to the present invention, the polymer mixture according to the present invention, and the method according to the present invention.

### EXAMPLES AND DRAWINGS

Further advantages and advantageous embodiments of the subject matters according to the present invention are illustrated by the examples and drawings and explained in the following description. It is pointed out that the examples and drawings are only descriptive in nature, and are not intended to limit the present invention in any way.

### BRIEF DESCRIPTION OF THE DRAWINGS

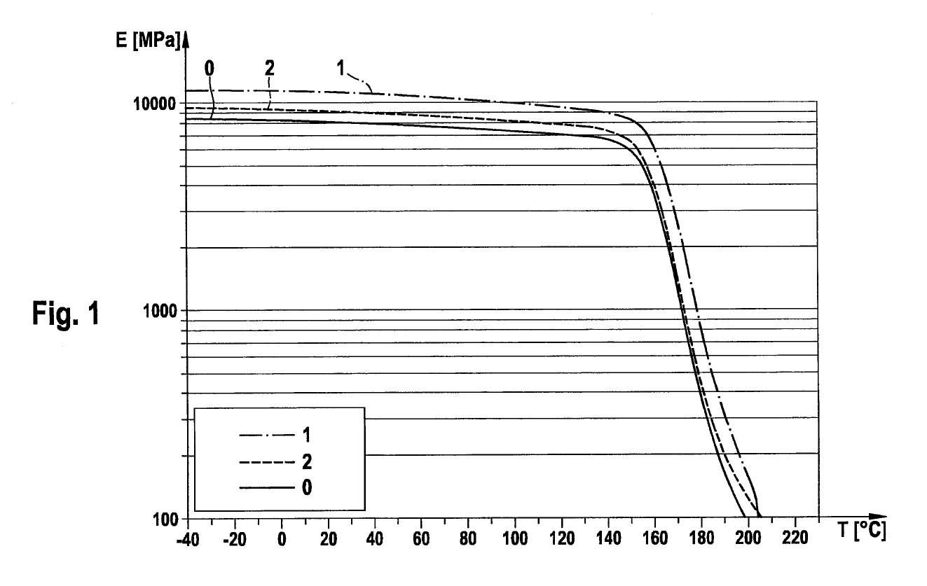

FIG. 1 shows a graph for comparing the moduli of elasticity of a first and a second copolymer according to the present invention to the corresponding pure polyphenylene.

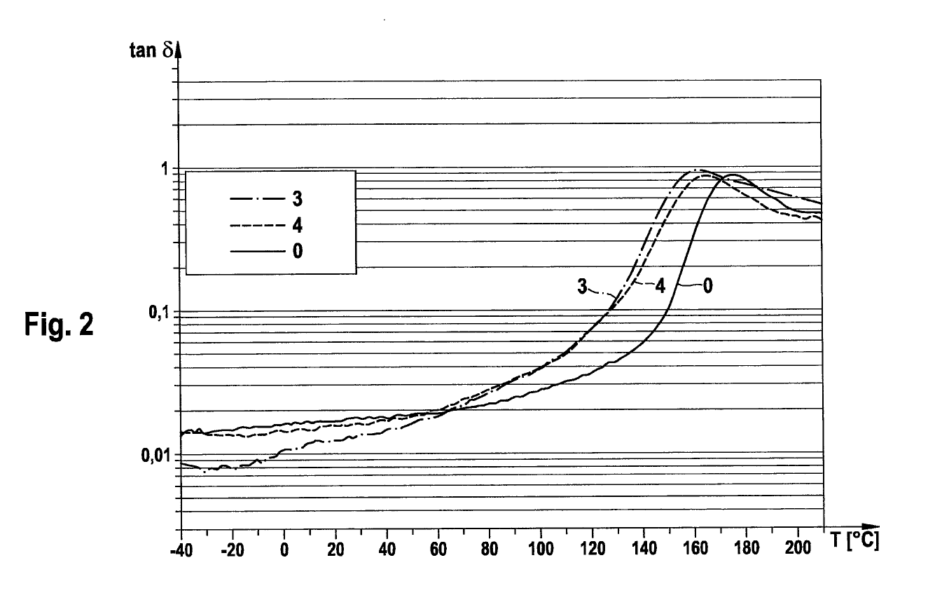

FIG. 2 shows a graph for comparing the glass transition temperature of a third copolymer according to the present invention to the corresponding pure polyphenylene and a corresponding longer-chain copolymer.

### DETAILED DESCRIPTION

### Examples

### 1. Preparation of tolyl ester-terminated poly(benzoyl-para-phenylene) (PBP-2E)

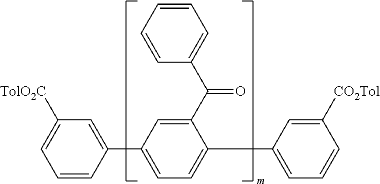

8.2 L anhydrous, degassed N-methyl-2-pyrrolidinone (NMP), 17.11 g (0.13 mol) anhydrous nickel(II) chloride (NiCl₂), 79.1 g (0.53 mol) anhydrous sodium iodide (NaI), 432.0 g (6.6 mol) activated zinc, and 415.8 g (1.59 mol) triphenylphosphine were placed in a 10-liter reactor having a KPG stirrer, an internal thermometer, and a reflux condenser, under nitrogen counterflow. The mixture was then stirred for approximately 3.5 h at an internal temperature of approximately 60° C. At this temperature, 1104.4 g (4.4 mol) 2,5-dichlorobenzophenone and 13.15 g (0.053 mol) 3-chlorobenzoic acid tolyl ester were subsequently added under nitrogen counterflow. During the initial two hours, the internal temperature was held by cooling the reactor so that 80° C. was not exceeded. Stirring was subsequently performed for 2 h at an internal temperature of approximately 70° C. After the reaction was complete, the cooled polymer mixture was precipitated in 42 L acetone. The polymer was subsequently separated from solid zinc in a mixture of 3 L ethanol and 1.4 L 50% hydrochloric acid. The polymer was purified by multiple washing processes with water (7×4 L) and acetone (5×5 L), and dried to constant weight at 80° C. under vacuum. The yield was 751 g. The average number of repeating units m was 48.

### 2. Preparation of Flexible Chain Components

### 2.1 Preparation of di-(6-aminohexyl)terephthalamide (6T6)

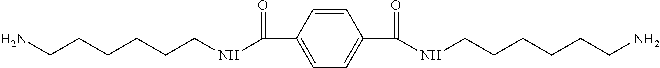

Di-(6-aminohexyl)terephthalamide was prepared according to Krijgsman J., Husken D., Gaymans R. J., Polymer, 44, 2003, 7043.

### 2.2 Preparation of di-(1,6-amino-2,2(4),4-trimethylhexane)[oligo(isophthal-1,6-diamino-2,2(4),4-trimethylhexane amide)] (OIPA)

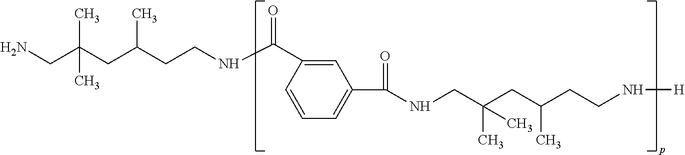

For p=1 (OIPA1), 31.83 g (0.1 mol) isophthalic acid diphenyl ester and 33.24 g (0.21 mol) 1,6-diamino-2,2(4),4-trimethylhexane were placed in a heated, nitrogen-cooled 250-mL three-necked flask having a KPG stirrer, a reflux condenser, and an internal thermometer, under nitrogen counterflow. The mixture was heated for 1 h at 90° C. and for 2.5 h at 110° C. The reflux condenser was replaced by a distillation apparatus, and lastly, phenol was distilled off over a period of 8 h at an internal temperature of 110° C. and a vacuum of approximately 0.05 mbar.

For p=4 (OIPA4), 788.8 g (2.48 mol) isophthalic acid diphenyl ester and 490.0 g (3.10 mol) 1,6-diamino-2,2(4),4-trimethylhexane were placed in a heated, nitrogen-cooled 3-liter reactor having a KPG stirrer and an internal thermometer, under nitrogen counterflow. The reactor was closed and heated to an internal temperature of 150° C. The following intervals were subsequently maintained: 2 h (150° C., approximately 0.4 bar), 2 h (200° C., approximately 1.0 bar), 1 h (230° C., approximately 1.8 bar), with ventilation of the reactor using nitrogen. Lastly, phenol was distilled off over a period of 2 h at an internal temperature of 200° C. and a vacuum of approximately 15 mbar.

For p=7 (OIPA7), 704.0 g (2.21 mol) isophthalic acid diphenyl ester and 400.0 g (2.53 mol) 1,6-diamino-2,2(4),4-trimethylhexane were placed in a heated, nitrogen-cooled 3-liter reactor having a KPG stirrer and an internal thermometer, under nitrogen counterflow. The reactor was closed and heated to an internal temperature of 150° C. The following intervals were subsequently maintained: 2 h (150° C., approximately 0.4 bar), 2 h (200° C., approximately 1.0 bar), 1 h (230° C., approximately 1.8 bar), with ventilation of the reactor using nitrogen. Lastly, phenol was distilled off over a period of 2 h at an internal temperature of 200° C. and a vacuum of approximately 15 mbar.

### 3. Copolymer Coupling Reactions

### 3.1 Reaction of tolyl ester-terminated poly(benzoyl-para-phenylene) (PBP-2E) with di-(6-aminohexyl)terephthalamide (6T6)

10.0 g tolyl ester-terminated poly(benzoyl-para-phenylene) and 0.4 g di-(6-aminohexyl)terephthalamide were dissolved in 110 mL N-methyl-2-pyrrolidinone (NMP). The solution was then refluxed for approximately 30 minutes. The solvent was then removed to dryness (in the later course of the distillation, by applying a vacuum).

### 3.2.1 Reaction of tolyl ester-terminated poly(benzoyl-para-phenylene) (PBP-2E) with di-(1,6-amino-2,2(4),4-trimethylhexane)[oligo(isophthal-1,6-diamino-2,2(4),4-trimethylhexane amide)] (OIPA4) in solution

10.0194 g tolyl ester-terminated poly(benzoyl-para-phenylene) at 150° C. under a nitrogen atmosphere was dissolved in 90 mL 1,3-dimethyl-3,4,5,6-tetrahydro-2(1H)-pyrimidinone in a 250-mL three-necked flask having a KPG stirrer and a reflux condenser. After cooling to room temperature, 1.4927 g di-(1,6-amino-2,2(4),4-trimethylhexane)[tetrakis(isophthal-1,6-diamino-2,2(4),4-trimethylhexane amide)] (OIPA4) (p=4) was added under nitrogen counterflow. The solution was stirred for 5 h at 250° C., and then precipitated in 1.1 L acetone. Lastly, the block copolymer was refluxed in acetone (2×200 mL).

### 3.2.2 Reaction of tolyl ester-terminated poly(benzoyl-para-phenylene) (PBP-2E) with di-(1,6-amino-2,2(4),4-trimethylhexane)[oligo(isophthal-1,6-diamino-2,2(4),4-trimethylhexane amide)] (OIPA4) in an extruder

Tolyl ester-terminated poly(benzoyl-para-phenylene) and di-(1,6-amino-2,2(4),4-trimethylhexane)[tetrakis(isophthal-1,6-diamino-2,2(4),4-trimethylhexane amide)] (OIPA4) (p=4) were reacted in an extruder on a kilogram scale, in a ratio corresponding to the previously described solution reactions, by melting (reactive extrusion) to form a block copolymer.

### 3.3 Reaction of tolyl ester-terminated poly(benzoyl-para-phenylene) (PBP-2E) with lauryl diamine (LDA)

10.0 g tolyl ester-terminated poly(benzoyl-para-phenylene) at 80° C. under a nitrogen atmosphere was dissolved in 90 mL N-methyl-2-pyrrolidinone in a 250-mL three-necked flask having a KPG stirrer and a reflux condenser. After cooling to room temperature, 0.220 g lauryl diamine was added under nitrogen counterflow. The solution was stirred for 2 h at 220° C. and then precipitated in 1.0 L acetone. Lastly, block copolymer was refluxed in acetone (2×150 mL).

### 4.1 Tests of Moduli of Elasticity

Table 1 below compares the moduli of elasticity (ascertained by DMA measurements) of several copolymers, composed of a polyphenylene and a flexible chain component, to those of the corresponding pure polyphenylene.

TABLE 1
Moduli of elasticity of copolymer compositions and pure polyphenylene

| | Poly- | | Flexible chain | Length of flexible | E-modulus | E-modulus |
|---|---|---|---|---|---|---|
| Poly- | phenylene | Flexible chain | component | chain of flexible | 20° C. | 120° C. |
| phenylene | (% by weight) | component | (% by weight) | chain component | [GPa] | [GPa] |
| PBP-2E | 96.2 | 6T6 | 3.8 | 20 | 11.0 | 9.5 |
| PBP-2E | 95.3 | OIPA1 | 4.7 | 19 | 9.3 | 8.1 |
| PBP-2E | 87.0 | OIPA4 | 13.0 | 58 | 8.9 | 7.6 |
| PBP-2E | 83.5 | OIPA7 | 16.5 | 97 | 7.7 | 5.7 |
| PBP-2E | 97.8 | LDA | 2.2 | 12 | 9.1 | 7.9 |
| PBP-2E | 100 | — | — | — | 8.1 | 7.2 |

Table 1 shows that a significant enhancing effect, i.e., an increase in the rigidity, was achieved by reacting the polyphenylene (PBP-2E) with a short-chain flexible chain component.

Table 1 shows in particular that copolymers PBP-2E/6T6, PBP-2E/OIPA1, PBP-2E/OIPA4, and PBP-2E/LDA according to the present invention have higher moduli of elasticity than the corresponding pure polyphenylene PBP-2E.

Table 1 also clearly shows that the enhancing effect is less with increasing chain length of the flexible chain component. Thus, copolymers PBP-2E/6T6, PBP-2E/OIPA1, PBP-2E/OIPA4, and PBP-2E/LDA according to the present invention in particular have higher moduli of elasticity than copolymer PBP-2E/OIPA7, whose flexible chain component has a flexible chain having a chain length of greater than 95 chain atoms.

FIG. 1 is a graph in which the modulus of elasticity of copolymer PBP-2E/6T6 1 according to the present invention, of copolymer PBP-2E/LDA 2 according to the present invention, and of the corresponding pure polyphenylene PBP-2E 0 are plotted as a function of temperature. FIG. 1 shows that copolymers PBP-2E/6T6 1 and PBP-2E/LDA 2 according to the present invention have a higher modulus of elasticity than the corresponding pure polyphenylene PBP-2E 0 over the entire temperature range.

### 4.2 Tests of the Glass Transition Temperature

FIG. 2 is a graph for comparison of the glass transition temperature of copolymer PBP-2E/OIPA4 3 according to the present invention to the corresponding pure polyphenylene PBP-2E 0 and a corresponding longer-chain copolymer PBP-2E/OIPA7 4. FIG. 2 shows that for the longer-chain copolymer PBP-2E/OIPA7 4, the working temperature is a function not only of the thermal properties of polyphenylene PBP-2E, such as the glass transition temperature and the softening temperature, but also of the thermal properties of flexible chain component OIPA7. Copolymer PBP-2E/OIPA7 4 already exhibits a significant decrease in rigidity, i.e., E-modulus, at the glass transition temperature of the flexible chain component (also see Table 1), so that it is not possible to make full use of the positive properties of polyphenylene PBP-2E. In contrast, the softening temperature of copolymer PBP-2E/OIPA4 3 according to the present invention is not significantly influenced by the flexible chain component, so that use may be made of the potential for good mechanical properties (also see Table 1) of polyphenylene PBP-2E up to elevated temperatures. Furthermore, FIG. 2 in combination with Table 1 shows that in the case of longer-chain copolymer PBP-2E/OIPA7 4, a mixed phase results in a reduction in the mechanical properties. FIG. 2 also shows that copolymers are present.

1-15. (canceled)

16. A copolymer which is prepared by reacting
a polyphenylene having two terminal coupling groups X₁ and X₂ with
a flexible chain component which has a flexible chain having two terminal coupling groups Y₁ and Y₂,
wherein each of coupling groups X₁ and X₂ reacts with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, and the flexible chain has a chain length of less than or equal to 95 chain atoms.

17. The copolymer of claim 16, wherein each of coupling groups X₁ and X₂ reacts with one of coupling groups Y₁ and Y₂, forming a carboxylic acid amide bond.

18. The copolymer of claim 16, wherein the polyphenylene has an average number of phenylene units greater than or equal to 40 and less than or equal to 60.

19. The copolymer of claim 16, wherein coupling groups X₁ and X₂ each independently stand for a carboxylic acid ester group, a carboxylic acid halide group, or a carboxylic acid group, and coupling groups Y₁ and Y₂ stand for an amine group.

20. The copolymer of claim 16, wherein the polyphenylene and the flexible chain component are used in a ratio of 1:10 to 10:1.

21. The copolymer of claim 16, wherein the reaction mixture includes ≧80% by weight to ≦99% by weight polyphenylene and ≧1% by weight to ≦20% by weight flexible chain component.

22. The copolymer of claim 16, wherein the reaction takes place in an extruder or kneader.

23. The copolymer of claim 16, wherein the flexible chain component is
a diaminoalkane, or
a diaminoalkene, or
a diaminoalkyne, or
a diaminoalkylterephthalamide, a diaminoalkylisophthalamide, or a diaminoalkylphthalamide, or
a diaminoalkyl(oligoterephthalalkylamide), a diaminoalkyl(oligoisophthalalkylamide), or a diaminoalkyl(oligophthalalkylamide), or
an aromatic diamine, or
a cycloaliphatic diamine, or
a diamino polymer, or
a diamino oligomer.

24. The copolymer of claim 16, wherein the flexible chain component is
1,2-diaminoethane, 1,3-diaminopropane, 1,4-diaminobutane, 1,5-diaminopentane, 1,6-diaminohexane, 1,8-diaminooctane, 1,10-diaminodecane, or 1,12-diaminododecane, or
di-(6-aminohexyl)terephthalamide, di-(6-aminohexyl)isophthalamide, or di-(6-aminohexyl)phthalamide, or
2,2′-bis-[4-(4-aminophenoxy]phenyl]propane, 1,2-phenylenediamine, 1,3-phenylenediamine, 1,4-phenylenediamine, or 4,4′-oxydianiline, or
4,4′-methyl-bis-cyclohexylamine, 1,3-bis-(aminomethyl)cyclohexane, or trans-1,4-diaminocyclohexane, or
a diaminopolyamide, a diaminopolycarbonate, a diaminopolyester, a diaminopolyesteramide, a diaminopolyester carbonate, a diaminopolyesterimide, a diaminopolythioester, a diaminopolyether, a diaminopolythioether, a diaminopolyimide, a diaminopolyamide-imide, a diaminopolybenzimidazole, a diaminopolybenzoxazole, a diaminopolybenzothiazole, a diaminopolyurethane, a diaminopolyurea, a diaminopolyoxazoline, a diaminopoly(meth)acrylate, a diaminopolysulfone, a diaminopolyether ketone, a diaminopolyether imide, a diaminopolyether sulfone, or a diaminopolyimide sulfone, or
a diamino-oligoamide, a diamino-oligocarbonate, a diamino-oligoester, a diamino-oligoester amide, a diamino-oligoester carbonate, a diamino-oligoester imide, a diamino-oligothioester, a diamino-oligoether, a diamino-oligothioether, a diamino-oligoimide, a diamino-oligoamidoimide, a diamino-oligobenzimidazole, a diamino-oligobenzoxazole, a diamino-oligobenzothiazole, a diamino-oligourethane, a diamino-oligourea, a diamino-oligooxazoline, a diamino-oligo(meth)acrylate, a diamino-oligosulfone, a diamino-oligoether ketone, a diamino-oligoether imide, a diamino-oligoether sulfone, or a diamino-oligoimide sulfone.

25. The copolymer of claim 16, wherein the flexible chain component is
a diaminoalkyl(oligoterephthalalkylamide) of general formula (III): 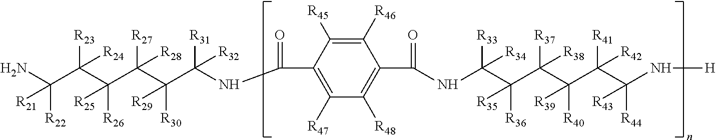
where R₂₃ through R₄₄ each independently stand for hydrogen or an alkyl group, for example a methyl group or ethyl group, n stands for the average number of repeating units, and is greater than or equal to 1 and less than or equal to 7,
a diaminoalkyl(oligoisophthalalkylamide) of general formula (IV): 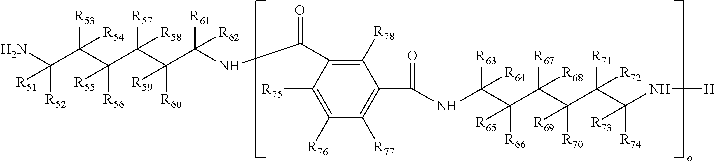
where R₅₁ through R₇₈ each independently stand for hydrogen or an alkyl group, for example a methyl group or ethyl group, o stands for the average number of repeating units, and is greater than or equal to 1 and less than or equal to 7, or
a diaminoalkyl(oligophthalalkylamide) of general formula (V): 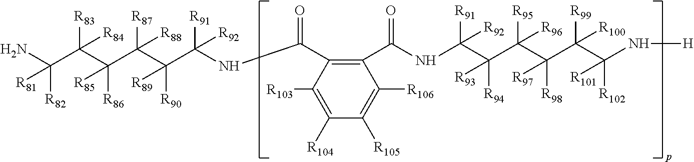
where R₈₁ through R₁₀₆ each independently stand for hydrogen or an alkyl group, for example a methyl group or ethyl group, p stands for the average number of repeating units, and is greater than or equal to 1 and less than or equal to 7, or
2,2′-bis-[4-(4-aminophenoxy)phenyl]propane, or
4,4′-methyl-bis-cyclohexylamine.

26. The copolymer of claim 16, wherein the polyphenylene is a polyphenylene of general formula (I): 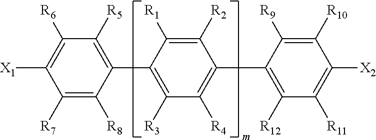
or of general formula (II): 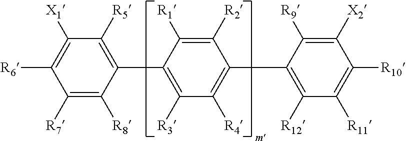
or of general formula (III): 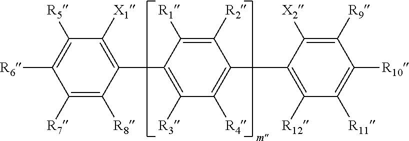
where
R₁ through R₁₂, R₁′ through R₁₂′, R₁″ through R₁₂″ each independently stand for hydrogen, an alkyl group, a heteroalkyl group, an alkyl ketone group, a heteroalkyl ketone group, an alkenyl group, an alkynyl group, an aryl group, a heteroaryl group, an alkoxy group, an aryloxy group, a heteroaryloxy group, an aralkyl group, a heteroaralkyl group, an alkaryl group, a heteroalkaryl group, an acyl group, a carboxylic acid group, a carboxylic acid ester group, a carboxylic acid alkyl ester group, a carboxylic acid aryl ester group, a carboxylic acid amide group, an alkylamide group, a dialkylamide group, an arylamide group, a diarylamide group, an alkylarylamide group, an alkyl ether group, an aryl ether group, an alkyl sulfide group, an aryl sulfide group, a sulfonyl group, an alkylsulfonyl group, an arylsulfonyl group, a thioether group, a halogen group, a haloalkyl group, a haloaryl group, a hydroxy group, or a silyl group,
X₁ and X₂, X₁′ and X₂′, X₁″ and X₂″ each independently stand for a carboxylic acid ester group, a carboxylic acid anhydride group, a carboxylic acid halide group, a carboxylic acid group, a nitrile group, an oxazoline group, an isocyanate group, a thioisocyanate group, a sulfonic acid group, a sulfonic acid halide group, a sulfonic acid ester group, an aromatic diamino group, a halogen group, a nitro group, an acetylene group, an epoxy group, an amine group, a thiol group, or an alcohol group, and
m, m′, m″ stand for the average number of repeating units, and is greater than or equal to 40 and less than or equal to 60.

27. The copolymer of claim 26, wherein R₄ stands for a benzoyl group, and R₁, R₂, R₃, and R₅ through R₁₂ stand for hydrogen.

28. A polymer mixture, comprising:
a copolymer which is prepared by reacting
a polyphenylene having two terminal coupling groups X₁ and X₂ with
a flexible chain component which has a flexible chain having two terminal coupling groups Y₁ and Y₂,
wherein each of coupling groups X₁ and X₂ reacts with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, and the flexible chain has a chain length of less than or equal to 95 chain atoms.

29. A method for preparing a copolymer, the method comprising:
providing a copolymer, which is prepared by reacting
a polyphenylene having two terminal coupling groups X₁ and X₂ with
a flexible chain component which has a flexible chain having two terminal coupling groups Y₁ and Y₂,
wherein each of coupling groups X₁ and X₂ reacts with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, and the flexible chain has a chain length of less than or equal to 95 chain atoms; and
reacting a polyphenylene having two terminal coupling groups X₁ and X₂ with a flexible chain component which has a flexible chain having two terminal coupling groups Y₁ and Y₂, each of coupling groups X₁ and X₂ reacting with one of coupling groups Y₁ and Y₂, forming a bond selected from the group composed of carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bonds, and the flexible chain having a chain length of less than or equal to 95 chain atoms.

30. Use of a copolymer,
wherein the copolymer is prepared by reacting
a polyphenylene having two terminal coupling groups X₁ and X₂ with
a flexible chain component which has a flexible chain having two terminal coupling groups Y₁ and Y₂,
wherein each of coupling groups X₁ and X₂ reacts with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, and the flexible chain has a chain length of less than or equal to 95 chain atoms.

31. Use of a polymer mixture,
wherein the polymer mixture includes:
a copolymer which is prepared by reacting
a polyphenylene having two terminal coupling groups X₁ and X₂ with
a flexible chain component which has a flexible chain having two terminal coupling groups Y₁ and Y₂,
wherein each of coupling groups X₁ and X₂ reacts with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, and the flexible chain has a chain length of less than or equal to 95 chain atoms.

32. Use of a copolymer,
wherein the copolymer is in a component which is in contact with a solvent, and
wherein the copolymer is prepared by performing the following:
providing the copolymer, which is prepared by reacting
a polyphenylene having two terminal coupling groups X₁ and X₂ with
a flexible chain component which has a flexible chain having two terminal coupling groups Y₁ and Y₂,
wherein each of coupling groups X₁ and X₂ reacts with one of coupling groups Y₁ and Y₂, forming a bond selected from the group composed of a carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bond, and the flexible chain has a chain length of less than or equal to 95 chain atoms; and
reacting a polyphenylene having two terminal coupling groups X₁ and X₂ with a flexible chain component which has a flexible chain having two terminal coupling groups Y₁ and Y₂, each of coupling groups X₁ and X₂ reacting with one of coupling groups Y₁ and Y₂, forming a bond selected from the group composed of carboxylic acid amide, carboxylic acid ester, carboxylic acid imide, urethane, carbonate, urea, thiourea, sulfonic acid amide, sulfonic acid ester, imidazole, oxazole, thiazole, oxazoline, imidazoline, amine, ether, and thioether bonds, and the flexible chain having a chain length of less than or equal to 95 chain atoms.
